(19) United States
(12) Patent Application Publication
(10) Pub. No.: US 2003/0024148 A1
(43) Pub. Date: Feb. 6, 2003

(54) Automatic fish hook and method of use

(76) Inventors: James J. Miller, Lafayette, LA (US); Francis E. Charleville IV, Lafayette, LA (US)

Correspondence Address: THE MATTHEWSFIRM, 1900 WEST LOOP SOUTH, STE. 1800, HOUSTON, TX, 77027, US

(21) Appl. No.: 10/086,600

(22) Filed: Feb. 28, 2002

Related U.S. Application Data
(63) Continuation of application No. 09/516,720, filed on Mar. 1, 2000, now abandoned.
(60) Provisional application No. 60/122,462, filed on Mar. 1, 1999.

(51) Int. Cl. A01K 83/02; A01K 83/00

(52) U.S. Cl. 43/36

(57) ABSTRACT

An improved automatic hook apparatus that deploys upon the application of generally opposing, lateral inward forces generated by the inside of a fish mouth and/or throat. The apparatus may be manually placed in a cocked position and then released upon the application of the two opposing, lateral, inward forces such that a fish may be hooked without the necessity of a fisherman manually setting the hook in the fish's mouth.

### RELATED APPLICATION

This application claims priority from U.S. Provisional Patent Application Serial No. 60/122,462 having a filing date of Mar. 1, 1999.

### TECHNICAL FIELD

The present invention relates generally to an apparatus that may be used to catch fish. More particularly, the present invention relates to fish hooks and more particularly to an improved automatic fish hook and method of use.

### BACKGROUND ART

Fishing over the years has changed from a necessity of survival to mainly sport and pleasure for a portion of the population. As fishing has developed, the type, quantity and specificity of the equipment used by the fisherman has also changed.

Most sport and pleasure fishing is accomplished by way of a hook and a line cast from a rod. However, the variety of this equipment available to a fisherman is extensive. There are numerous rod, reel and line combinations available for the fisherman to choose from. Each type or selection is advertised to be suited for a particular type of fish or a particular type of environment. Moreover, the choice of the proper rod and reel combination, or rig as a fisherman might refer to it, directly effects a fisherman's probability of catching fish.

Beyond the rod and reel combinations, the variety and types of hooks a fisherman may choose from is tremendous. Hooks exist that are single pointed, double pointed, triple pointed and so on, with barbs, without barbs and multiple barbs. However, the majority of the prior art hooks share one characteristic. That characteristic being that the point is shaped from a metal shank with an eyelet on one end and the point and barb on the other end. This arrangement may be commonly referred to as a hook.

Fishing has developed such that a bait or lure of some type may be placed about the point end of the hook. The hook may then be cast or placed into the water. When a fisherman feels or observes something, hopefully a fish attempting to remove the bait, the fisherman sets the hook. Setting the hook requires the fisherman to move the line attached to the hook so that the hook would catch the fish by contacting the fish with a point of the hook.

The proper setting of the hook is perhaps the most difficult part of fishing to learn. It is often regarded as the most difficult part of fishing because different types of fish require different movements and forces to properly set the hook. Unfortunately, many fish are not caught because the hook is not set properly.

There have been attempts in the prior art to solve this problem. One such attempt is disclosed in U.S. Pat. No. 5,890,314 entitled Self-Setting Hook Configuration for Weedless Fishing Lures. In that patent, a spring biased dual hook assembly is disclosed that is activated when either the fisherman or the fish pulls on the apparatus. The releasable apparatus disclosed by the patent is deployed only by the fish or fisherman applying force against the line. Accordingly, this self-setting hook is sometimes not self-setting at all, but rather requires a pulling movement of the line to provide a tension upon the hook and deploying of the spring. For example, if the assembly is inside the fish mouth and the fish swims toward the fisherman, the hook will not set.

Accordingly, it is an object of the present invention to provide an improved automatic hook apparatus.

### SUMMARY

By way of example, the description of the invention that follows will be given in relation to an automatic fish hook However, those of ordinary skill in the art will readily see that the invention may be used for a wide variety of functions. The disclosure that follows is not meant to limit the scope of the invention.

An embodiment of the present invention generally relates to a fishing hook designed to automatically set in a fish's mouth. The closing of the fish's mouth produces two generally opposing, lateral, inward forces sufficient to automatically set the hook.

In the preferred embodiment of the invention, the automatic hook is comprised of two hooks extending about a coil with a notch along the coil. The coil tends to keep the hooks biased in a certain direction.

As a feature of the preferred embodiment, the tensioner coil that may be adjusted to effectuate the angle of the bias of the hooks from the coil. The tensioner may be releasable secured in a notch such that two generally opposing, lateral, inward forces are required to release the bias along the hooks.

In this preferred embodiment, releasing the hooks through the generally opposing, lateral, inward forces caused by opposing sides of the fish mouth tends to cause the hooks to return to an unbiased position. This unbiased position is such that the hooks are facing away from one another. In this unbiased position with the hooks facing away from one another, a fish may be caught on the hooks.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 is an illustration of an embodiment of the present invention disassembled into a preferred embodiment's component pieces.

FIG. 2 is an illustration of the assembled embodiment of FIG. 1 in which the bias on the tensioner is relaxed.

FIG. 3 is an illustration of the embodiment of FIG. 2 in which the bias on the tensioner is not relaxed.

FIG. 4 is an illustration of a perspective end view of the embodiment of FIG. 2.

FIG. 5 is an illustration of an alternative embodiment of the present invention wherein the apparatus is formed from a single wire.

FIG. 6 is an illustration of an embodiment of the invention of in a cocked position.

FIG. 7 is an illustration of the embodiment of FIG. 6 in an uncocked position.

FIG. 8 is an illustration of an embodiment of the present invention at use in an aquatic environment.

FIG. 9 is an illustration of an embodiment of the present invention at use in an aquatic environment

FIG. 10 is an illustration of an embodiment of the present invention at use in an aquatic environment.

### GENERAL DESCRIPTION AND PREFERRED MODE FOR CARRYING OUT THE INVENTION

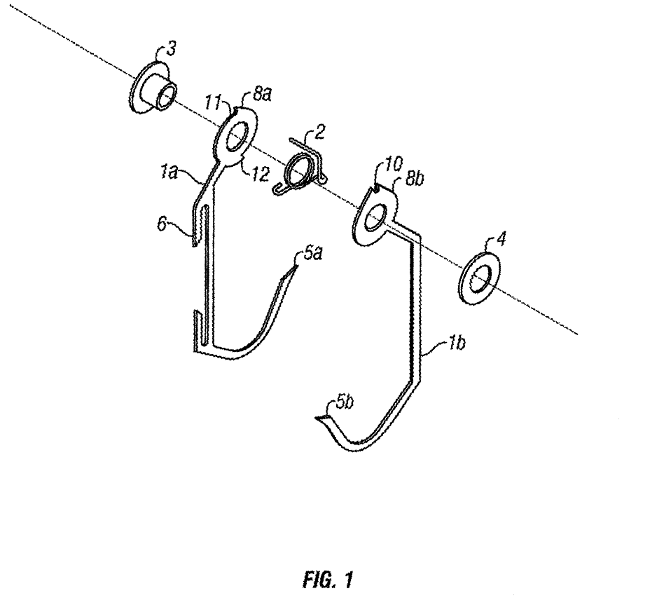

Referring now to FIG. 1, an illustration of an embodiment of the present invention disassembled into a preferred embodiment's component pieces. The present invention envisions several components in one embobiment. However, other embodiments of the invention envision a single piece of material configured into the present invention. In a multi piece preferred embodiment, during assembly, shank 1a and shank 1b are arranged such that point 5a and point 5b are adjacent one another. Then flange 8a and flange 8b are aligned such that tensioner 2 is placed between flange 8a and flange 8b.

Next a hollow bore brad backing 3 may be inserted through flange 8a, through tensioner 2, and through flange 8b while keeping the general orientation of shank 1a and shank 1b. In this embodiment, tensioner 2 is then arranged such that a portion of tensioner 2 may be placed in angled slot 10 on flange 8b. Hollow bore brad retainer 4 is then applied to hollow bore brad backing 3 to complete assembly of the apparatus.

In this embodiment, flange 8a has an upper cam 11 and a reverse angle cam 12. When the tensioner 2 is assembled in this embodiment, reverse angle cam 12 may act a s a mechanical stop to prevent over rotation of tensioner 2.

It may be noted that in a preferred embodiment, shank 1a or shank 1b may have an prong 6 that may be used to attach a body of a lure, worm, bait, or other desired items. Prong 6 may be a folded clip or simply an abutment of the member to provide an area for attaching the desired items.

It may also be evident to those of ordinary skill in the art that point 5a and point 5b may be any shape common in the art such as straight, bent, twisted or hooked.

FIG. 1, an illustration of an embodiment of the present invention disassembled into a preferred embodiment's component pieces, illustrates an embodiment of the present invention with a single pointed member on point 5a and point 5b. However the invention contemplates the use of multiple points. The invention also contemplates the use of a barb disposed about point 5a and/or point 5b.

Further, the embodiment in FIG. 1, an illustration of an embodiment of the present invention disassembled into a preferred embodiment's component pieces, illustrates a common orientation of a hook. However, the invention contemplates other orientations common in the art such as straight, bent, twisted, and others.

The choice of materials for embodiments of the present invention is not limited to any particular material. However, common examples would be a metal selected from the group consisting of steel, iron, aluminum, copper, an alloy of steel, an alloy of iron, an alloy of aluminum, an alloy of copper and combinations thereof. Additionally, the present invention may be constructed of a composite material or plastic such as polyvinyl chloride and the like.

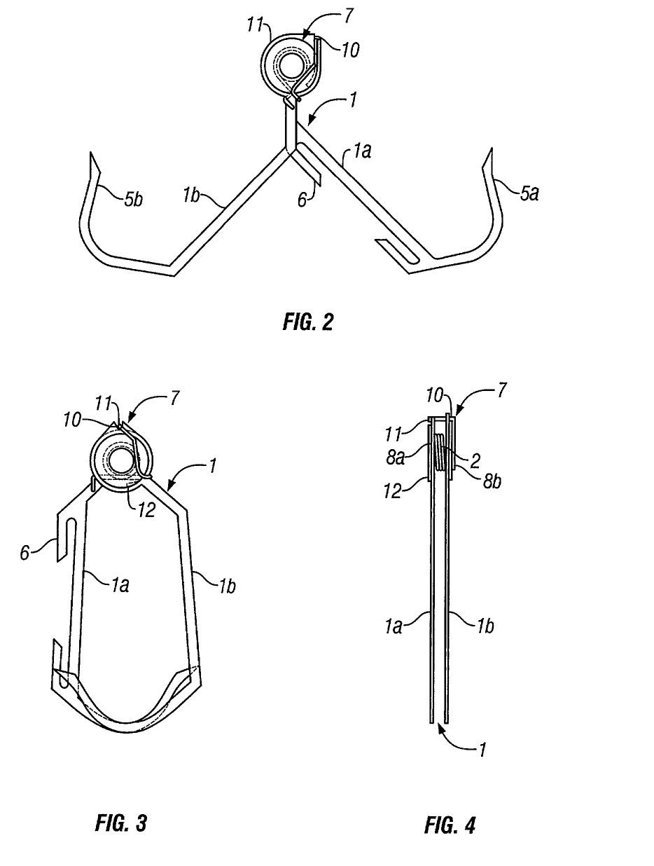

Referring now to FIG. 2, an illustration of a preferred embodiment of the present invention in which the bias on tensioner 2 is relaxed and not in the cocked or prepared position, it may be observed that tensioner assembly 7 biases a shank 1a and shank 1b such that point 5a and point 5b are in directions generally opposed to the other. Tensioner assembly 7 is defined to include flange 8a, flange 8b, hollow bore brad backing 3, hollow bore brad retainer 4, slot 10, upper cam 11 and reverse cam 12. To cock or prepare this embodiment of the present invention for fishing, a user will apply a generally opposing, lateral, inward force on shank 1a and a generally opposing, lateral, inward force on shank 1b to place shank 1a and shank 1b in position where upper cam 11 is adjacent to angled slot 10 so tensioner 2 may extend across upper cam 11. Extending tensioner 2 across upper cam 11 provides resistance to the centrifugal force created along tensioner 2 by the application of the opposing forces in preparing the apparatus for use by placing the apparatus in the cocked position.

This embodiment of the present invention may releasably remain in the cocked position illustrated in FIG. 3, an illustration of an embodiment of the present invention in which the bias on the tensioner is not relaxed until a lateral, inward force acts upon shank 1a towards a generally opposed lateral, inward force acting upon shank 1b. In use, the generally opposing, lateral, inward forces are supplied by the interior of the mouth and/or throat of a fish. Upon the application of the forces sufficient to overcome the resistance created by upper cam 11 on tensioner 2, the apparatus may return to the uncocked position as described in FIG. 2. In returning to the uncocked position, this embodiment may expose point 5a and point 5b.

Referring now to FIG. 3, an illustration of a preferred embodiment of the present invention in which the bias on the tensioner 2 is not relaxed. Shank 1a and shank 1b will held in this cocked position by tensioner 2 and upper cam 11 with reverse cam 12 as a mechanical stop to prevent over rotation of tensioner mechanism 7. This cocked position in this embodiment is the preferred orientation for use.

It will be apparent to those of skill in the art that the preferred embodiment of the present invention as illustrated by FIG. 3 may have shank 1a and shank 1b disposed parallel such that point 5a and point 5b are partially obscured thereby reducing the frequency in which point 5a or point 5b may become hooked or in direct contact with unintentional items such as algae, seaweed, trees, rocks and the like.

Referring now to FIG. 4, an illustration of a perspective, side view of the device of FIG. 2. In this preferred embodiment of the present invention shank 1a and shank 1b are not in contact. Tensioner 2 is arranged between flange 8a and flange 8b. FIG. 4 is an illustration of a perspective of the invention from the side in a cocked position. Tensioner assembly 7 is set by tensioner 2 extending across angled slot 10 and upper cam 11 with a mechanical stop in reverse cam 12.

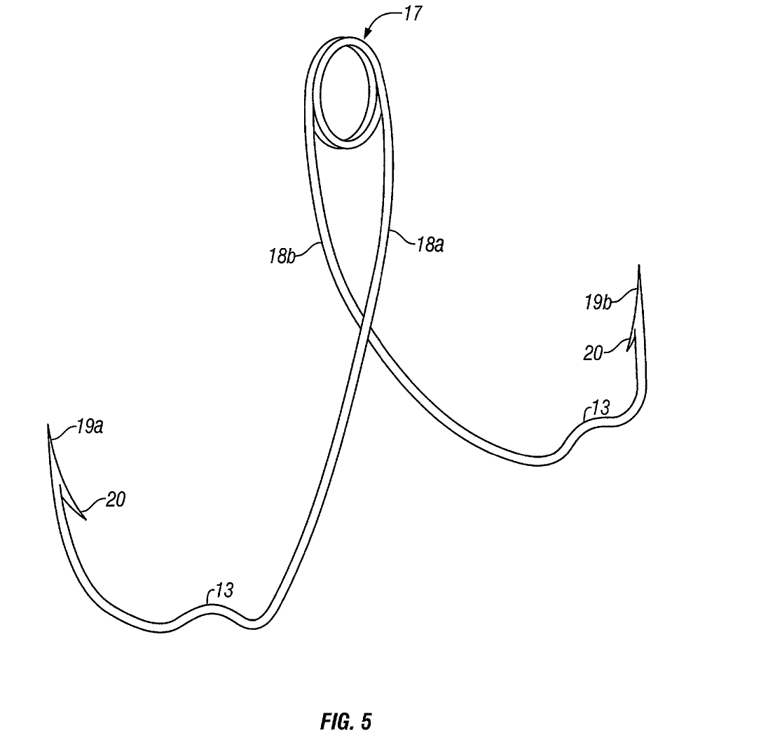

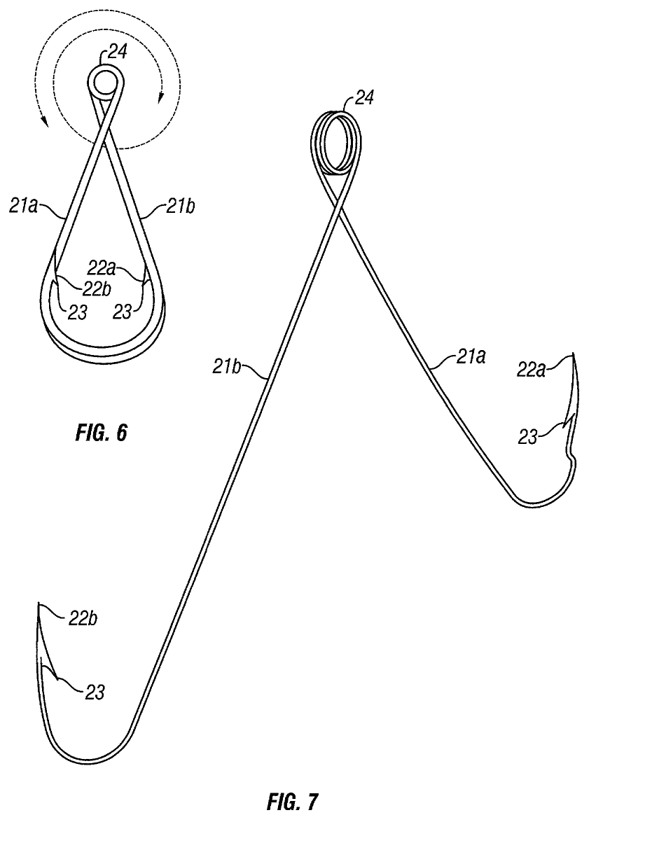

Referring now to FIG. 5, an illustration of an alternative embodiment of the present invention wherein the apparatus is formed from a single wire. It should be apparent that the present invention encompasses embodiments formed from more or less portions than a preferred embodiment described above. About the middle, the wire will be coiled a sufficient number of times to provide adequate bias. A preferred embodiment utilizes two coils in tensioner mechanism 17. Shank 18a and shank 18b extend from tensioner mechanism 17 in a crossing pattern in a first position. Shank 18a and shank 18b then terminate in at a point 19a and point 19b respectfully. It may also be observed that this preferred embodiment has barb 20 on point 19a and barb 20 on point 19b. Shank 18a and shank 18b may be bent in different orientations along shank 18a and shank 18b. This one piece design may then be cocked by grasping the apparatus above the intersection of shank 18a and shank 18b and applying a generally opposing, lateral, inward force on shank 18a and shank 18b below the intersection of shank 18a and shank 18b to move the apparatus to a cocked position (as shown in FIG. 6). A latch mechanism 13 may be disposed along the shank to assist the apparatus in remaining cocked.

Referring now to FIG. 6, an illustration of the alternate embodiment of the invention in a cocked position. In an embodiment of a one piece apparatus shank 21a and shank 21b may be disposed such that point 22a and point 22b are partially obscured thereby reducing the frequency in which point 22a or point 22b may become hooked or in direct contact with unintentional items such as algae, seaweed, trees, rocks and the like.

Referring now to FIG. 7, an illustration of the alternate embodiment of the present invention in an uncocked position. FIG. 7 illustrates another preferred embodiment of the present invention with barb 23 on point 22a and barb 23 on point 22b along shank 21a and 21b.

Referring now to FIG. 8, an illustration of an embodiment of the present invention at use in an aquatic environment. The embodiment of FIG. 8 has a body 25 over the apparatus and is attached to line 16. When the automatic apparatus is released, point 27a and point 27b with barb 26 may be exposed. Slats or openings may be along body 25 such that point 27a and point 27b may become exposed upon the application of two opposing forces generally in direction of one another.

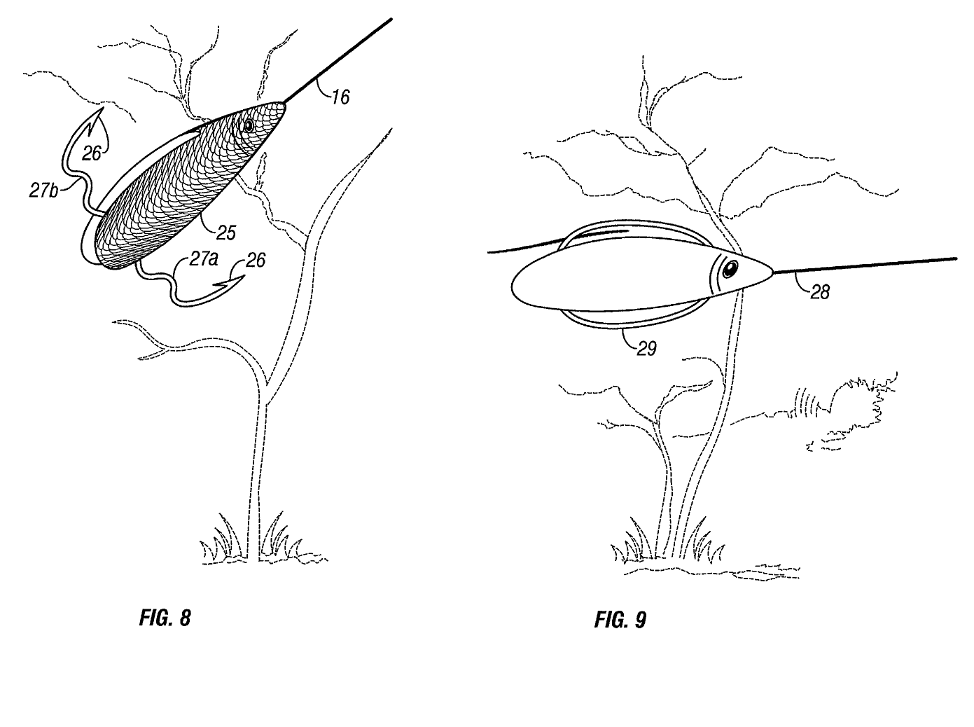

Referring now to FIG. 9, an illustration of an embodiment of the present invention at use in an aquatic environment with an automatic apparatus obscured by a body 29. Body 29 is releasably secured to line 28. Line 28 may be any available line such as string, a composite material or the like.

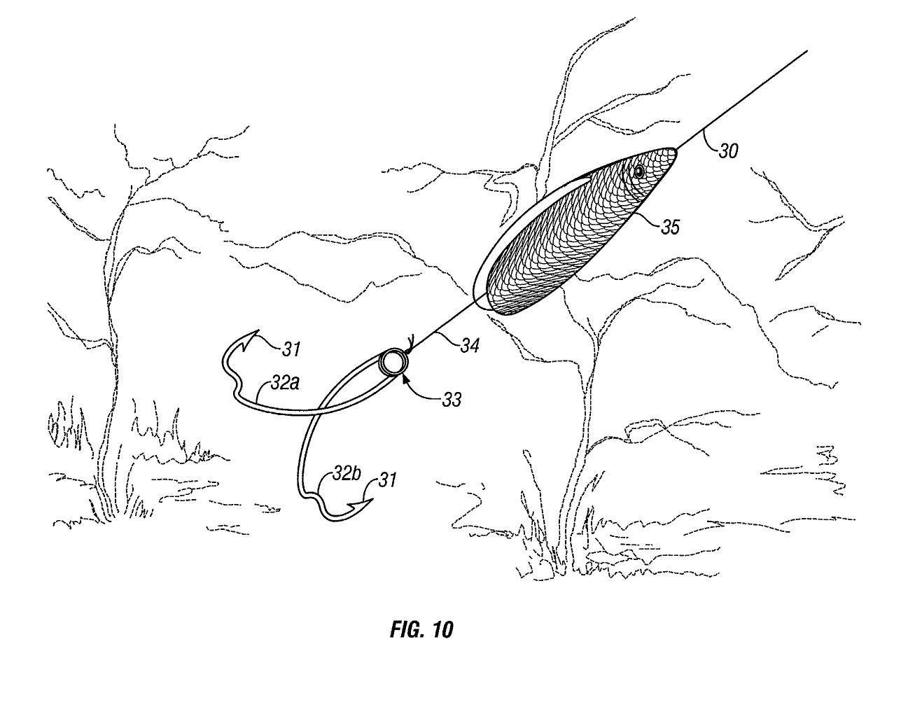

Referring now to FIG. 10, an illustration of an embodiment of the present invention at use in an aquatic environment. It may be observed that line 30 may be releasably attached to a body 35 that may be further releasably attached by a line 34 to a tensioner mechanism 33. The attachment of line 30 and line 34 may be of any manner common in the art. A preferred embodiment utilizes over-hand knots. Other knots will be readily apparent to those of skill in the art. It will be further observed that this embodiment utilizes Shank 32a and shank 32b may be set behind body 35.

It will be readily apparent to those of ordinary skill in the art that thickness of wire, hook, tensioner, and shank will affect the operation of embodiments of the present invention.

Further, those of ordinary skill in the art will see that the preferred embodiment described above is only one configuration possible from the claims. It is envisioned that the tensioner apparatus may be adjusted along shank 1a, shank 1b, point 5a and point 5b to effectuate different orientations.

The present invention also envisions a method of use. That method of use may generally follow as such:

A method of fishing wherein a fisherman may attend a rod or may leave a rod unattended and still set a hook in a fish's mouth comprising the steps of:

using an automatic hook assembly with a first and a second ends that requires opposing, lateral, inward forces applied along the hook assembly between the first and second ends to be in a cocked position;

using a fishing line having first and second ends;

securing the fishing line at its the first end to the first end of the hook assembly;

casting the fishing line into a body of water whereby the fisherman retains the second end of the fishing line; and,

retracting a fish from the body of water after the fish uses its mouth and/or throat to cause the hook assembly to expand outwardly into the body of the fish.

A preferred method of the present invention envisions the use of a rod and reel during fishing operations. This rod and reel may be used for casting and reeling in the line attached to the automatic hook. Further, in a preferred method of use, a body or bait is attached about the line.

Various other methods and apparatuses are within the scope of this invention and will be apparent to those of ordinary skill in the art.

What is claimed is:

1. An improved automatic fish hook apparatus comprising:
a first member having a first end and a second end;
a second member having a first end and a second end;
a tensioner disposed intermediate the first member and the second member from about the first end of the first member and about the first end of the second member, the tensioner having a first state and a second state; and
a latch having a first latch position and a second latch position, the latch disposed proximate the first end of the first member and the first end of the second member and releasably in communication with the tensioner,
whereby
the first latch position maintains the tensioner in the first state and the second latch position releases the tensioner into its second state.

2. The improved fish hook of claim 1 wherein the first member is a hook.

3. The improved fish hook of claim 1 wherein the second member is a hook.

4. The improved fish hook of claim 2 wherein the hook further comprises a barb disposed about the second end of the hook.

5. The improved fish hook of claim 3 wherein the hook further comprises a barb disposed about the second end of the hook.

6. The improved fish hook of claim 1 wherein the tensioner is a spring.

7. The improved fish hook of claim 1 wherein the tensioner is a coil.

8. The improved fish hook of claim 1 wherein the latch is a cam.

9. The improved fish hook of claim 1 further comprising a prong along the first member.

10. The improved fish hook of claim 1 wherein the second position disposes the first member and the second member substantially parallel and the second position disposes the first member and the second member crossed.

11. The improved fish hook of claim 9 wherein the prong is a body.

12. The improved fish hook of claim 1 further comprising an eyelet disposed about intermediate the first member and the second member.

13. The improved fish hook of claim 1 wherein the latch may be released upon the application of two generally opposing forces applied along the first member and the second member.

14. The improved fish hook of claim 13 wherein the two generally opposing forces are generally in a direction of one another.

15. The improved fish hook of claim 1 wherein the latch is disposed about the tensioner.

16. The improved fish hook of claim 1 wherein the latch is disposed about the first member.

17. The improved fish hook of claim 1 wherein the first end of the first member and the first end of the second member is a flange.

18. The improved fish hook of claim 1 wherein the tensioner further comprises a brad.

19. The improved fish hook of claim 19 wherein the brad is a hollow bore brad.

20. The improved fish hook of claim 1 wherein the first member is composed of a metal.

21. The improved fish hook of claim 20 wherein the metal is selected from the group consisting of steel, iron, aluminum, copper, an alloy of steel, an alloy of iron, an alloy of aluminum, an alloy of copper and combinations thereof.

22. The improved fish hook of claim 1 wherein the first member is composed of a composite material.

23. An improved releasably biasable apparatus comprising:
a first member having a first end and a second end;
a second member having a first end and a second end;
a tensioner disposed intermediate the first member and the second member, the tensioner having a first state and a second state; and
a latch having a first latch position and a second latch position, the latch disposed about the first member and the second member and releasably in communication with the tensioner,
whereby
the first latch position maintains the tensioner in the first state and the second latch position releases the tensioner into its second state.

24. A method of fishing wherein a fisherman may attend a rod or may leave a rod unattended and still set a hook in a fish's mouth comprising the steps of:
using an automatic hook assembly with first and second ends that requires opposing, lateral, inward forces applied along the hook assembly between said first and second ends to be in a cocked position;
using a fishing line having first and second ends;
securing the fishing line at its the first end to the first end of the hook assembly;
casting the fishing line into a body of water whereby the fisherman retains the second end of the fishing line; and,
retracting a fish from the body of water after the fish uses its mouth and/or throat to cause the hook assembly to expand outwardly into the body of the fish.

25. The method of claim 24 wherein the line is secured along a fishing pole at the first end.

26. The method of claim 24 wherein the fishing pole further comprises a fishing rod and reel.

27. The method of claim 26 wherein the first end of the line is secured along the fishing reel.

28. The method of claim 27 wherein collecting the line further comprises actuating the reel.
